(19) United States
(12) Patent Application Publication
(10) Pub. No.: US 2026/0056537 A1
(43) Pub. Date: Feb. 26, 2026

(54) BUILDING AUTOMATION SYSTEM WITH EDGE DEVICE SELF-MONITORING & REPAIR

(71) Applicant: Tyco Fire & Security GmbH, Neuhausen am Rheinfall (CH)

(72) Inventors: Daniel R. Gottschalk, Racine, WI (US); Mark Fischbach, New Berlin, WI (US); WenSu Lu, Buffalo Grove, IL (US); Vivek Vishnu Gupta, Menomonee Falls, WI (US)

(73) Assignee: Tyco Fire & Security GmbH, Neuhausen am Rheinfall (CH)

(21) Appl. No.: 18/821,946

(22) Filed: Aug. 30, 2024

Related U.S. Application Data
(60) Provisional application No. 63/686,553, filed on Aug. 23, 2024.

(51) Int. Cl. G05B 23/02

(52) U.S. Cl. CPC G05B 23/0275; G05B 23/0264

(57) ABSTRACT

An edge controller for building equipment includes circuitry programmed to provide a data bus locally on the edge controller, a plurality of containerized applications executing on the edge controller by exchanging data with the data bus, and a controller health application executing on the edge controller and monitoring health of the plurality of containerized applications via the data bus.

### CROSS-REFERENCE TO RELATED APPLICATIONS

This application claims priority to and the benefit of U.S. Provisional Patent Application No. 63/686,553 filed Aug. 23, 2024, the entire disclosure of which is incorporated by reference herein.

### BACKGROUND

The present disclosure relates generally to building equipment and building automation systems. Conventional building automation systems include complex architectures that can require a wide number of devices, supervisory and field controllers, on-premises servers, off-premises servers, and other infrastructure to be manually configured by field technicians in order to establish and maintain a building automation system. Such architectures may be suitable for large scale facilities but substantially different in structure than building automation systems for smaller scale entities, leading to extra complexity (e.g., driven by higher numbers of different tools and platforms) and preventing or complicating comparisons across facilities of different type and size. Additionally, each of such building devices may have limited functionality or execute limited types of logic and diverse devices, including different equipment, sensors, data sources, etc. (including within a given building), often use different protocols and data formats which create barriers to integrations and reduce interoperability between building devices. The present disclosure addresses these and other challenges.

### SUMMARY

One implementation of the present disclosures is an edge controller for building equipment. The edge controller includes circuitry programmed to provide a data bus locally on the edge controller, a plurality of containerized applications executing on the edge controller by exchanging data with the data bus, and a controller health application executing on the edge controller and monitoring health of the plurality of containerized applications via the data bus.

In some embodiments, the controller health application is configured to provide health monitoring via data logging using at least a subset of the data exchanged with the data bus by the plurality of containerized applications. The controller health application may be configured to execute a self-repair routine for the edge controller in response to detecting an issue with at least a first application of the plurality of containerized applications. The self-repair routine can include using at least one artificial intelligence model to identify a resolution to the issue and automatically implementing the resolution at the edge controller.

In some embodiments, the controller health application is configured to log additional data streaming on the data bus in response to detecting an issue with at least a first application of the plurality of containerized applications. The controller health application may be configured to log the additional data by saving the additional data to local data storage of the edge controller. In some embodiments, the circuitry comprises a port coupled to the data bus to receive measurements from a sensor and provide an output to the sensor and the device health application is configured to cause the output to be provided to the sensor in response to detecting the issue, the output causing the sensor to stream the additional data to the data bus. The sensor may be a camera.

In some embodiments, the circuitry is further programmed to provide a network connection to a remote server. The device health application may be configured to generate a bundle comprising the additional data and provide the bundle to the remote server via the network connection.

In some embodiments, the controller health application is further configured to attempt execution of a plurality of resolutions to a plurality of issues with the plurality of applications, log results of the execution of the plurality of resolutions to the plurality of issues with the plurality of applications, and train, locally on the edge device, a machine learning model of the controller health application to determine a future resolution based on the log.

In some embodiments, the controller health application is configured to, check known endpoints for connectivity, check for a network connection in response to at least one of the endpoints lacking connectivity, and, in response to a combination of the network connection and the at least one of the endpoints lacking connectivity, collect logs from a subset of the plurality of containerized applications based on the subset using the endpoint and take a corrective action based on the logs.

In some embodiments, the controller health application is configured to monitor streaming data on the data bus while the edge controller abstains from transmitting at least some of the streaming data off of the edge controller.

Another implementation of the present disclosure is a building management system. The building management system includes an equipment unit operable to heat, cool, or ventilate a building space, a sensor configured to measure a condition of the building space, an edge controller configured to receive a measurement of the condition of the building space from the sensor and control the equipment unit. The edge controller is further programmed to provide a data bus locally on the edge controller and configured to receive the measurement from the sensor and enable a control output to be provided to the equipment unit and a plurality of containerized applications executing on the edge controller by exchanging data with the data bus. At least one of the plurality of containerized applications generating the control output based on the measurement, and a controller health application executing on the edge controller and monitoring health of the plurality of containerized applications via the data bus.

In some embodiments, the edge controller is located at a building site proximate the equipment unit and the sensor. In some embodiments, the controller health application is configured to provide health monitoring via data logging using at least a subset of the data exchanged with the data bus by the plurality of containerized applications and execute a self-repair routine for the edge controller in response to detecting an issue with at least a first application of the plurality of containerized applications.

In some embodiments, the self-repair routine includes using at least one artificial intelligence model to identify a resolution to the issue and automatically implementing the resolution at the edge controller. In some embodiments, the controller health application is configured to check connectivity to one or more endpoints. In some embodiments, the controller health application is configured to log additional data streaming on the data bus in response to detecting an issue with at least a first application of the plurality of containerized applications. The controller health application may be configured to cause the sensor to provide the additional data to the data bus in response to detecting the issue. The sensor can be a camera and the additional data can be streaming video.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a first block diagram of a building automation system, according to some embodiments.

FIG. 2 is a second block diagram of a building automation system, according to some embodiments.

FIG. 3 is a block diagram of edge circuitry and a cloud system of a building automation system, according to some embodiments.

FIG. 4 is an example illustration of a cloud manager interface for managing logic executed by edge circuitry, according to some embodiments.

FIG. 5 is an example illustration of an events viewer interface showing event alerts generated by the edge circuitry using logic managed by the cloud manager, according to some embodiments.

FIG. 6 is a first view in a distributor dashboard, according to some embodiments.

FIG. 7 is a second view in the distributor dashboard, according to some embodiments.

FIG. 8 is a block diagram of an automation system, according to some embodiments.

FIG. 9 is a flowchart of a process for monitoring connectivity, according to some embodiments.

FIG. 10 is a flowchart of a process for diagnosing and resolving connectivity issues, according to some embodiments.

FIG. 11 is a diagram of logic for monitoring connectivity, according to some embodiments.

### DETAILED DESCRIPTION

Referring generally to the figures, advances in building automation systems are shown according to various embodiments. For example, in some embodiments an edge device is provided with a controller health application operating locally on the edge device and monitoring, via a common data bus, health of applications that exchange data with the common data bus. The controller health application can detect and diagnose issues with controller performance in real-time and using data which may not be available to other approaches such as remote troubleshooting or customer service centers or the like. The controller health application can, for example, automatically (e.g., using artificial intelligence) determine an action to take to resolve (e.g., self-repair) a detected issue with controller operations and automatically execute such a self-repair, thereby providing the edge device with improved reliability, reduce downtime, etc., The edge device can also be configured to store bundles of logged data associated with detected issues (e.g., with logging triggered responsive to issue detection), for example for use in reinforcement learning of models used for issue detection and resolution and/or for presentation to an external system or use, for example accompanied by a summary of the data represented in the bundled logs (e.g., generated by generative artificial intelligence).

Various additional advances described herein, in various embodiments, leverage multi-domain expertise to embed intelligence and data at the edge, enable faster deployment of building equipment and building automation systems via a plug-and-play architecture, seamlessly share data and optimize multiple competing demands using the organized data, provide a scalable architecture enabled to work across different size buildings from large/complex (e.g., hospital, headquarters) to light commercial (e.g., retail storefront, small office), provide a hybrid architecture with on-premises capabilities and cloud readiness, are future-proofed by over-the-air update capabilities, provide high levels of cyber security, and/or provide an easy on-ramp for advanced digital features. The building automation systems herein may enable fixed function controls, configurable controls, pro-figurable functions, and/or programmable/fully-customizable functions in various embodiments and at various scales.

The present disclosure contemplates, in some embodiments, factory-shipping packaged control circuitry with a unit of building equipment (e.g., a rooftop unit, a chiller, etc.) (i.e., as an integrated package, on one pallet, positioned in shared housing, etc.), where the onboard/integrated circuitry provides various advanced data ingestion, machine learning, expression-based pattern recognition, and/or other control and analytics functions as detailed below. The present disclosure also contemplates retrofitting existing buildings or equipment by installing such circuitry with existing equipment, in some implementations. Such circuitry may further include embedded cloud bridge technology and/or building twin technology to enable hybrid digital functionalities in seamless and direct interaction with cloud services including cloud-based digital twins, edge-based digital twins, or a combination thereof. Such unification of advanced functionalities at the edge can drive local improvements for internal operation of a unit of building equipment, plug-and-play higher-order cloud analytics and control optimizations, and automatic data standardization and aggregation enabling visualizations across facilities, owners, customers, and equipment types.

These and other features and advantages are described in further detail below with reference to the drawings.

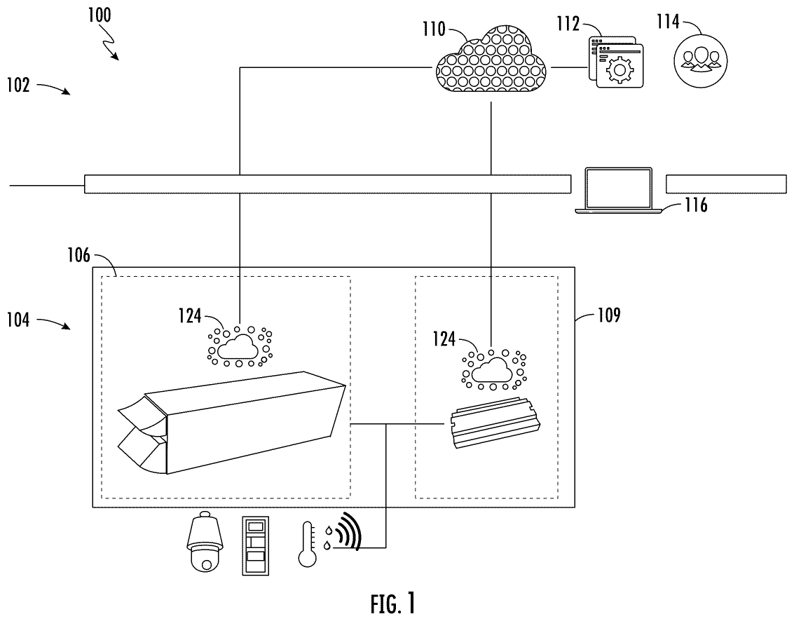

Referring now to FIG. 1, a building automation system 100 is shown according to some embodiments. The building automation system 100 is shown as including a cloud tier 102 and an on-premises tier 104, where the on-premises tier 104 includes an equipment unit 106 with edge circuitry 108 (e.g., onboard circuitry, local circuitry) communicable directly with the cloud tier 102 and in particular with cloud system 110 of the cloud tier 102 (e.g., via only network communications infrastructure, internet architecture, without intervening supervisory or field controllers, etc.). The cloud tier 102 is also shown as including cloud applications 112 and remote services 114, both or either which may be executed by or via cloud system 110, for example. A unified pane 116 is accessible via the cloud tier 102 and/or the on-premises tier 104 and provides visualizations of and user interactivity with the building automation system 100 and data relating thereto. The on-premises tier 104 is shown as including various data sources, shown as security sensor 118, fire alarm pull 120, and a temperature sensor 122.

While FIG. 1 shows the security sensor 118, fire alarm pull 120, and temperature sensor 122. In various embodiments, the data sources can include various sensors (security sensors, cameras, door sensors, smoke detectors, fire sensors, indoor temperatures sensors, pressure sensors, outdoor temperature sensors, humidity sensors, occupancy sensors, air quality sensors, flow meters, power meters, etc.), equipment (e.g., rooftop units, chillers, air handling units, variable air volume boxes, etc.), or other devices or systems (e.g., building scheduling system, thermostats, nurse call system, etc.). The data sources can include local sources located at a same facility as the rooftop unit, internal sources at or proximate the rooftop unit, peer sources communicating in a peer-to-peer fashion with the onboard circuitry, and/or external sources communicating directly with the onboard circuitry or only via devices located at the same facility. The data sources can provide (e.g., stream substantially continuously, periodically transmit, etc.) signals (data, information, etc.) to the edge circuitry 108.

The equipment unit 106 and the edge circuitry 108 can share a housing 109, for example with a heating, ventilation, or cooling component (e.g., compressor, evaporator, valve, actuator, fan, damper, cooling coil, heating coil, etc.) of the equipment unit 106 and the edge circuitry 108 both coupled to and/or enclosed within the housing 109. In some embodiments, the equipment unit 106 and the edge circuitry 108 are packaged together at a factory or warehouse and delivered as an integrated package (e.g., coupled to a common pallet) to a building site for installation. In the example of FIG. 1, the equipment unit 106 is a rooftop unit. The equipment unit 106 may be one or more of various other types of building equipment in other embodiments (e.g., chiller, air handling unit, variable air volume box, cooling tower, actuator, valve, air purifier, water heater, boiler, thermal energy storage, battery, variable refrigerant flow outdoor unit, variable refrigerant flow indoor unit, lighting device, controllable security device, controllable fire safety device, etc.). The equipment unit 106 is operable to affect a variable condition of a building (e.g., temperature, humidity, airflow, air quality, pressure, brightness, lighting color temperature, etc.).

As shown in FIG. 1, the equipment unit 106 and the edge circuitry 108 include a bridge communications layer 124 that enables communication between the on-premises tier 104 and the cloud tier 102. The bridge communications layer 124 is configured to provide a bridge between the edge circuitry 108 and the cloud system 110, for example as described in U.S. Provisional Patent Application No. 63/296,078, filed Jan. 3, 2022, the entire disclosure of which is incorporated by reference herein. The edge circuitry 108 can store a portion of a digital twin of a facility served by the equipment unit 106, for example a digital twin with event enrichment and contextual information as described in U.S. application Ser. No. 17/504,121 filed Oct. 18, 2021, the entire disclosure of which is incorporated by reference herein. In some implementations, the bridge communications layer 124 may additionally or alternatively perform certain processing and/or storage, such as processing of remotely programmed rules or artificial intelligence/machine learning routines and/or storage of digital twins, on-premises, such as at the equipment unit 106.

The cloud tier 102 is shown as including a cloud system 110 and associated cloud applications 112 and remote services 114. The cloud applications 112 can include fault prediction, detection, and diagnostic features that predict, detect, and/or diagnose faults of the equipment unit 106, and, in some embodiments, recommend maintenance or automatically cause a change in control of the equipment unit 106 to prevent or mitigate such faults. As another example, the cloud applications 112 can include optimization applications that perform optimizations configured to reduce utility costs, energy usage, carbon emissions, or some combination thereof, for example subject to constraints that ensure occupant comfort, and provide control settings (e.g., zone temperature setpoints) to the equipment unit 106 as the output of such applications (e.g., for example, as described in U.S. Patent Publication No. 2020/0041158, filed Oct. 10, 2019 and/or U.S. patent application Ser. No. 17/668,791, filed Feb. 10, 2022, the entire disclosures of which are incorporated by reference herein. As another example, the cloud applications 112 can include sustainability tools for managing pollution emissions (e.g., carbon emissions) and/or generating control settings for the equipment unit 106 to achieve an emissions target (e.g., net zero energy consumption), for example as described in U.S. Provisional Patent Application No. 63/301,910, filed Jan. 21, 2022, the entire disclosure of which is incorporated by reference herein. In some implementations, the cloud applications 112 may include features relating to assessing and improving occupant, space/building and/or environment health, indoor air quality, and/or infection risk, for example as described in U.S. Provisional Patent Application No. 63/230,608, filed Aug. 6, 2021, U.S. patent application Ser. No. 17/459,963, filed Aug. 27, 2021, and U.S. Provisional Patent Application No. 63/281,409, filed Nov. 19, 2021, the entire disclosures of each of which are incorporated herein by reference. While these features are described as being optional parts of the cloud applications 112, it should be understood that, in various implementations, aspects of the features may additionally or alternatively be implemented as part of the on-premises tier 104, such as within the edge circuitry 108. For example, in some implementations, one or more of these or other features may be implemented fully within the edge circuitry 108, and in some implementations, a portion of the features may be implemented within the edge circuitry 108 and a portion may be implemented within the cloud applications 112 (e.g., such that the edge circuitry 108 and the cloud applications 112 work in concert to execute the features). The remote services 114 can enable expert access to data relating to the equipment unit 106 and expert interventions relating to operation of the equipment unit 106, for example.

In some implementations, the architecture shown in FIG. 1 may have several advantages over a more conventional, multi-tiered building automation system (BAS) architecture. A multi-tiered BAS architecture may include, for example, edge devices such as rooftop units (RTUs), chillers, air handling units (AHUs), and the like, and may further include multiple layers of controllers to interface with such units. For example, in such an architecture, an edge device such as a RTU may interface with a field controller, which may be located proximate to or otherwise in direct communication with the RTU. The field controller may in turn interface with a supervisory controller, which may interact with local, on-premises controls and/or cloud or other off-premises services.

In some implementations of the present disclosure, as illustrated in FIG. 1, the edge devices, such as the RTU, may interface directly with cloud or other off-premises systems/services via the edge circuitry 108. Accordingly, some implementations of the present disclosure provide a flattened architecture relative to a multi-tiered architecture and may, for example, remove the need for one or more intervening controllers (e.g., field controllers, supervisory controllers, etc.). In some implementations, some functions of such devices may be implemented in the edge circuitry 108, the cloud applications 112, or a hybrid thereof.

Such an architecture can substantially reduce the time to install a new building management system/building automation system (e.g., reducing installation and configuration time from weeks to hours, in some instances). The architecture may support over the air updates and remote serviceability through the cloud tier 102. The architecture may support higher-order analytics that may be performed at the cloud tier 102, the on-premises tier 104 (e.g., at the edge circuitry 108), or by a hybrid combination thereof. The architecture may allow for quicker and easier configuration of such analytics as well (e.g., reducing the time to onboard/activate particular analytics services, such as from weeks to hours in some cases). The architecture may support automated configuration of some equipment and services. In some implementations, the architecture may reduce or eliminate the need for multiple, disjointed user interfaces, data models, and other tools and instead allow for a unified set of tools/models/interfaces to be applied across a variety of equipment/spaces/buildings/applications/etc.

It should be understood that edge circuitry, as utilized herein, does not require that the described components/apparatus be separate and distinct circuitry, such as separate circuitry from that of edge devices such as rooftop units or chillers. Rather, in various implementations, the edge circuitry or other circuitry described herein may be implemented as separate hardware and/or software, integrated with or be a part of existing hardware/software of existing devices, such as edge devices like rooftop units/chillers or other on-premises computing devices such as servers or controllers, or a combination thereof. In some implementations, the edge circuitry or other circuitry described herein may be implemented as instructions stored on one or more computer-readable storage media, such as storage media of an existing device or on a separate storage medium, that are executable by one or more processors (e.g., processors of existing equipment or other processors) to implement functions described herein. In some implementations, the instructions may be added to one or more on-premises devices, such as by providing some or all of the instructions to the devices during manufacturing or after installation/during operation via in-person or remote programming of the devices.

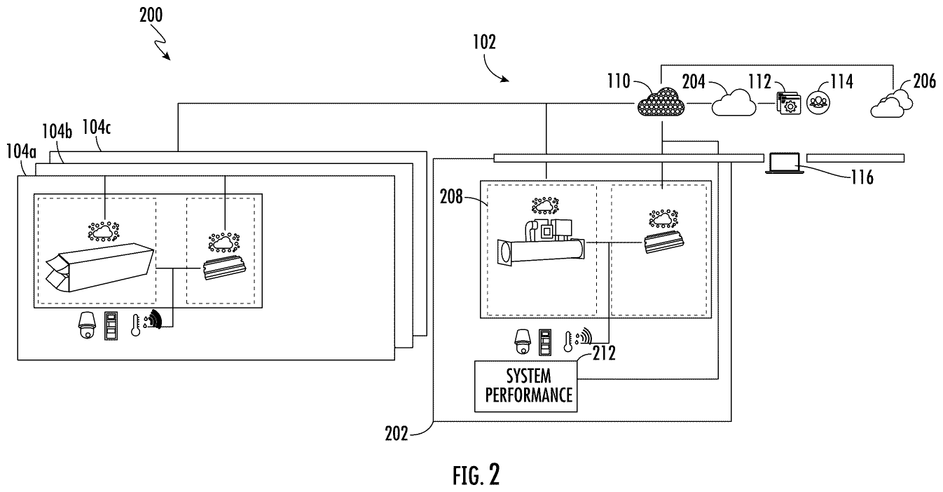

Referring now to FIG. 2, an enterprise system 200 is shown, according to some embodiments. The enterprise system 200 can be characterized as an extension of the building automation system 100 of FIG. 1 for multiple facilities. Advantageously, the enterprise system 200 uses the same architecture as the building automation system 100, with the architecture being agnostic to the count of the number of different of facilities included, the count of the number of different equipment units included, and of the size of a facility or multiple facilities included in the enterprise system 200. The architecture and other features disclosed herein are thus usable across buildings, campuses, and enterprises of different scales and complexities (an including internal differences in scale and complexity) without change in architecture. In the example shown, the enterprise system 200 includes the cloud tier 102 and instances of the on-premises tier 104 at multiple buildings (shown as three retail branches with on-premises tier 104a, on-premises tier 104b, and on-premises tier 104c, respectively). The enterprise system 200 also includes an instance of the on-premises tier for a different type of building, shown as edge tier 202 for a headquarters building.

In the example of FIG. 2, the cloud tier 102 includes the cloud system 110, the cloud applications 112, and the remote services 114, with user access via unified pane 116. The cloud tier 102 is also shown as including digital twin 204 and a third party cloud 206. The digital twin 204 can be a digital twin as described in U.S. application Ser. No. 17/504,121 filed Oct. 18, 2021, the entire disclosure of which is incorporated by reference herein. The third party cloud 206 can be any cloud system, resource, service, etc. which provides data useful to the cloud applications 112, remote services 114, or digital twin 204 and/or uses outputs of the cloud applications 112, remote services 114, digital twin 204, on-premises tiers 104a-c, or edge tier 202 to provide various functionality in various embodiments.

The edge tier 202 for a headquarters building is shown as including an equipment unit 208 which may be a different type of equipment than equipment unit 106 of on-premises tier 104 as shown in FIG. 1 (and as in on-premises tiers 104a-c in FIG. 2 in various examples). The edge tier 202 may include multiple equipment units 208 in various embodiments. For example the equipment unit 106 for a retail branch may be an rooftop unit while a headquarters building may have other plant equipment as the one or more equipment units 208 (e.g., chiller(s), boiler(s), etc.), or may have a more complex/larger rooftop unit or set of multiple rooftop units. The edge tier 202 also includes edge circuitry 210 coupled to, enclosed with, packaged with, distributed with, integrated with, etc. the equipment unit 208. The edge circuitry 210 advantageously has the same or similar design as edge circuitry 108 of FIG. 1, for example with adaptations for use with the type of equipment of equipment unit 208. Various data sources can be connected thereto as above with reference to FIG. 1, with FIG. 2 showing that complex systems 212 such as an on-premises system performance system, etc. (e.g., hosted on an on-premises server) can be included and communicate directly with the edge circuitry 210 (e.g., without first routing through the cloud system 110) and/or with the cloud system 110. In some implementations, such complex systems 212 may be integrated as a part of the edge circuitry 210.

FIG. 2 is illustrative of the scalability of the architecture of the present disclosure across different facilities, campuses, enterprises, real estate portfolios, equipment distribution networks, service areas, etc., according to some embodiments. Although retail branches and a headquarters is shown in the example shown, various other combinations of different types of facilities are possible (e.g., residential, classroom, athletics, and laboratory facilities of a college campus; hospital, clinic, and pharmacy facilities of a medical group; storefronts, factories, and warehouses of a consumer goods business; hotels and corporate offices for hotel groups; stadiums and corporate offices for the ownership groups; airport terminals and other airport operations facilities and/or office spaces; etc.). The architecture can enable services appropriate for such facilities (e.g., using three-dimensional building models of the relevant buildings) without requiring modification to the underlying architecture of the building automation systems shown in FIGS. 1-2.

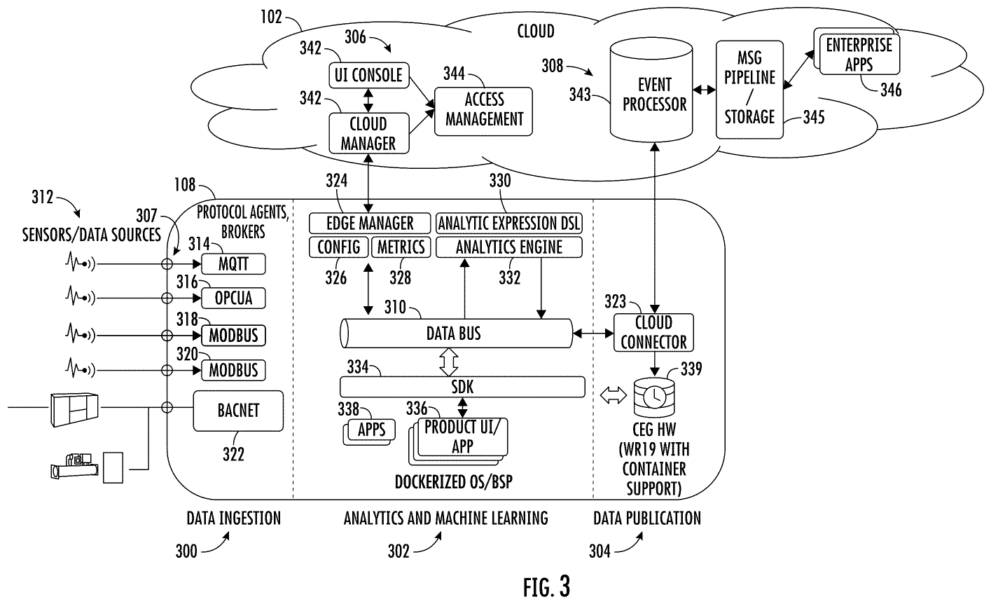

Referring now to FIG. 3, a detailed view of cloud tier 102 interoperating with edge circuitry 108 is shown, according to some embodiments. The edge circuitry 108 is shown as including a data ingestion layer 300, an analytics layer 302, and a data publication layer 304. The cloud tier 102 is shown as including an analytics management portion 306 and a cloud processing portion 308. The analytics management portion 306 interoperates with the analytics layer 302 of the edge circuitry 108 while the cloud processing portion 308 interoperates with the data publication layer 304.

The data ingestion layer 300 is configured to ingest data from multiple sources received from the sources in multiple data formats and using multiple data protocols, translate the data into a common data format, and provide the data in the common data format to a common data bus 310 of the analytics layer 302. In some embodiments, the data ingestion layer 300 and elements thereof can be implemented using features for ingesting and processing streaming data and/or sets of data as described in U.S. Pat. No. 10,007,513, filed Aug. 29, 2016, U.S. Pat. No. 11,048,498, filed Aug. 13, 2019, U.S. Pat. No. 10,572,230, filed Mar. 23, 2017, and/or U.S. Pat. No. 10,564,941, filed Mar. 23, 2017, the disclosures of which are incorporated by reference herein in their entireties. The common data format may be a Brick format, for example, or any other type of common data model. The data ingestion layer may apply tags to the data, for example tags indicating types of the entities, relationships between the entities, for example location, event, asset, and place tags. The data ingestion layer 300 can also provide various pre-processing steps, including normalizing, aligning (e.g., arranging data from multiple sources into discrete values at a common frequency/time step interval), filtering, cleaning, etc. the data received at the data ingestion layer 300 before providing such data to the data bus 310.

As shown in FIG. 3, the data ingestion layer 300 includes multiple inputs 307 (ports, pins, wireless receivers, etc.) that receive signals (data, etc.) from sources 312 and provide such signals to an MQTT agent 314, an OPCUA agent 316, a Modbus agent 318, a DDS agent 320, and a BACnet agent 322. The MQTT agent 314 is configured to translate data from a MQTT protocol to a common data format used by the data bus 310 (e.g., data from an internet-of-things sensor). The OPCUA agent 316 is configured to translate data from a OPCUA protocol to the common data format. The Modbus agent 318 is configured to translate data (e.g., from a building sensor) from a Modbus protocol to the common data format. The DDS agent 320 is configured to translate data from a DDS protocol to the common data format. The BACnet agent 322 is configured to translate the data (e.g., internal data of the unit of building equipment, data from other building equipment) from a BACnet protocol to the common data format. The agents 314-322 can be selectively included and excluded depending on the data protocols of the data sources communicably coupled to the edge circuitry 108, including in some examples by adding an agent for a new protocol via an over-the-air update when a data source using the new protocol is connected. The agents 314-322 can translate the data in real time (e.g., in substantially continuous streams) so that real-time data is provided onto the data bus 310. Such local data translation avoids latency issues which may delay data processing in alternative embodiments where such data translations are performed at an off-premises server. While the agents 314-322 can in some implementations be implemented using software agents, it should be understood that, in other implementations, the protocol brokers/translation layers may be implemented using methods other than software agents.

The analytics layer 302 is configured to execute one or more of multiple types of logic, including control logic (e.g., a PID feedback control loop), expression-based event processing and/or pattern recognition, and/or one or more machine learning or artificial intelligence algorithms/routines (e.g., a machine learning algorithm specifically modified to have a smaller memory footprint thereby enabling edge execution). Such logic is performed using data in a common data format from data bus 310 and can include sending control signals to the equipment unit 106 (i.e., to electromechanical components that operate in accordance with such control signals to affect a condition of a building) or transmitting results to the cloud tier 102 via a cloud connector 323 of the data publication layer 304.

The analytics layer 302 is shown as including the data bus 310, edge manager 324, configurator 326, metrics 328, analytic expression domain specific language 330, analytics engine 332, software development kit 334, product applications 336, and other applications 338. The data bus 310, edge manager 324, configurator 326, metrics 328, analytic expression domain specific language 330, analytics engine 332, and software development kit 334 are shown as exchanging information with the data bus 310, while the other applications 338 and the product applications 336 interoperate with the data bus 310 via the software development kit 334 in the illustration shown.

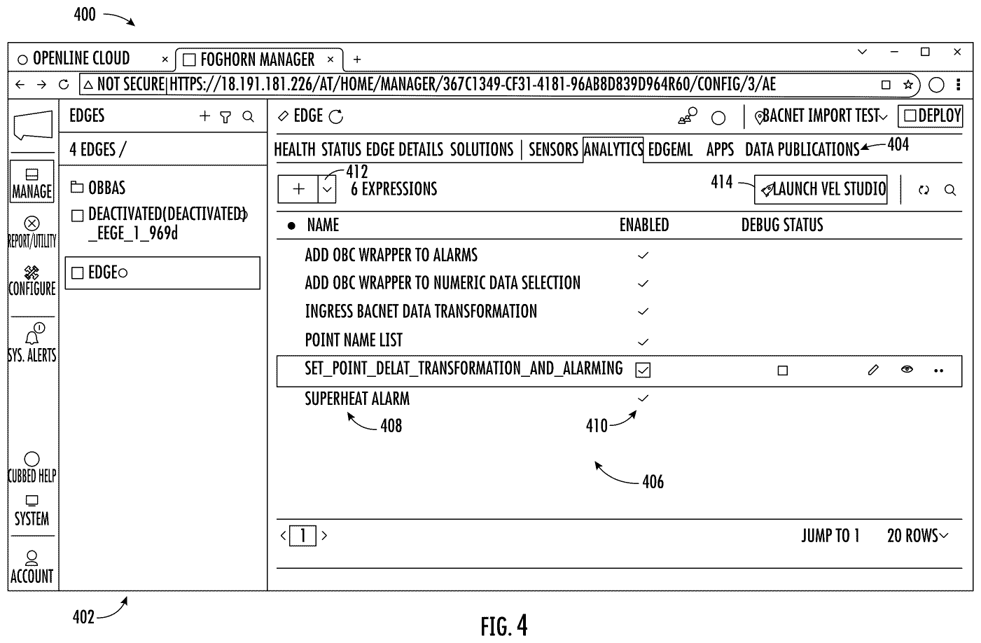

The edge manager 324 interoperates with a cloud manager 340 of the analytics management portion 306 of the cloud tier 102. The cloud manager 340 provides information and receives inputs from a user interface console 342 (e.g., a browser-based interface hosted by the cloud manager 340 and accessible via the Internet from a person computing device). The cloud manager 340 and the user interface console 342 interact with an access management system 344 which determines whether a user has authority to manage the edge circuitry 108 (e.g., based on login credentials, etc.) and, in response to determining that the user has authority to manage the edge circuitry 108, allowing the user to access the user interface console 342 and to interact with the cloud manager 340. An example interface displayed by the user interface console 342 and providing interactions with the cloud manager 340 to manage analytics executed by the analytics layer 302 is shown in FIG. 4 and described with reference thereto below. New or updated expression-based logic can be transmitted remotely to the edge circuitry 108 to enable over the air updates of the edge circuitry 108 and, in some scenarios, other similar edge circuitry for similar edge devices in a network.

The cloud manager 340 provides for creation of and modifications to various logic executed by the analytics layer 302. As one example, the cloud manager 340 allows a user (via user interface console 342) to select or create expression-based logic for execution by the analytics layer 302. For example, the cloud manager 340 may provide tools and methods for a real-time data flow programming language as described in U.S. Pat. No. 10,977,0101, filed Apr. 21, 2020, and/or U.S. Pat. No. 10,127,022, filed Mar. 23, 2017, the entire disclosures of which are incorporated by reference herein. The expression-based logic may enable complex event processing that can perform real-time analysis of disparate streams of data (e.g., collected on data bus 310), simultaneously perform complex pattern recognition on high frequency and asynchronous streaming data, detect events in real time (enabling immediate response such as closed loop control actions), and handle machine learning pre- and post-processing. For example, the expression-based logic may be selected or customized via the cloud manager 340 to define fault diagnosis rules based on trends in data on the data bus 310 (e.g., comparing rates of change of different variables from different data sources). Such expression-based logic can be stored at analytic expression DSL 330 and executed by analytics engine 332 of the analytics layer 302 of the edge circuitry 108.

As another example, the cloud manager 340 is configured to train a neural network (or other machine learning or artificial intelligence model), for example on historical data of configuration, events, performance, etc. of the equipment unit 106 and/or other equipment units (e.g., similar equipment units serving similar buildings). The cloud manager 340 may provide the trained neural network to the edge manager 324. In some embodiments, the cloud manager 340 modifies the trained model in a manner that reduces the memory and computing resources needed to run an algorithm using the model, and provides the modified model to the edge circuitry 108. The model can be edge-converted (“edge-ified”) as described in U.S. Patent Publication No. 2020/0327371, filed Apr. 9, 2019, the entire disclosure of which is incorporated by reference herein. The modified (edge-converted, edge-ified, etc.) model may be usable by the edge circuitry 108 use continuous streams of data as inputs from the data bus 310 and produce inferences (predictions, diagnoses, control outputs) without communication to the cloud tier 102. The cloud manager 340 can periodically update the edge-converted model in a closed-loop manner by interoperating with the edge manager 324, for example. The edge-converted model can be stored by the edge manager 324 on the edge circuitry 108 and used in one or machine learning algorithms, for example executed by the analytics engine 332 of the analytics layer 302. In some embodiments, the edge-converted model is provided onto data bus 310 so that it can be used by apps 338 and product apps 336 via SDK 334.

The cloud manager 340 and user interface console 342 can also enable various other automated or user-selected adjustments of settings and control logic, for example. For example, a user may select temperature setpoints, desired temperature ranges, preferences for comfort versus costs or energy or carbon savings, etc. which may be used by various control logic (e.g., PID feedback controller, extremum seeking controller, etc.), analytics, or model-based processes (e.g., model predictive control, predictive maintenance, etc.) performed by the edge circuitry 108.

Configurator 326 of the analytics layer 302 is configured to automatically determine a configuration for the edge circuitry 108 and the equipment unit 106. The configuration can include multiple parameters that tune the edge circuitry 108 and the equipment unit 106 to or toward ideal performance. In some embodiments, the configurator 326 uses expression-based event processing logic to assess data from the data bus 310 and uses results of such expression-based event processing logic to determine configuration parameters. In some embodiments, the configurator 326 uses a machine learning model (e.g., an edge-converted machine learning model, trained on historical configurations of similar equipment units) to determine a configuration. In some embodiments, the configurator 326 interoperates with the cloud manager 340 to determine the configuration in a hybrid cloud/edge manner, for example with the configurator 326 and the cloud manager 340 determining different subsets of configuration parameters. In some embodiments, the configurator 326 and/or the cloud manager 340 (e.g., in coordination with the user interface console 342) perform operations for automatic configuration as described in U.S. Pat. No. 11,272,011, filed May 19, 2021, the entire disclosure of which is incorporated by reference herein.

As shown in FIG. 3, the analytics layer 302 is dockerized such that various apps 338 and product apps 336, (and analytic expressions, machine learning models, etc.) can be modularly added or removed from the analytics layer 302, for example via over-the-air updates. The apps 338 and product apps 336 can include various control logic for the equipment unit 106, for example. The apps 338 and the product apps 336 can include various other programs, analytics, metrics calculators, visualization generators, etc. that enable various capabilities for the equipment unit 106.

The edge circuitry 108 is further shown as including the data publication layer 304. The data publication layer 304 includes cloud connector 323 and CEG HW 339. The cloud connector 323 is configured to provide a bridge between the edge circuitry 108 (e.g., the data bus 310) and the cloud tier 102 (e.g., the cloud processing portion 308), for example as described in U.S. Provisional Patent Application No. 63/296,078, filed Jan. 3, 2022, the entire disclosure of which is incorporated by reference herein. The CEG HW 339 provides for data updates to and from the cloud tier 102, for example via SDK 334.

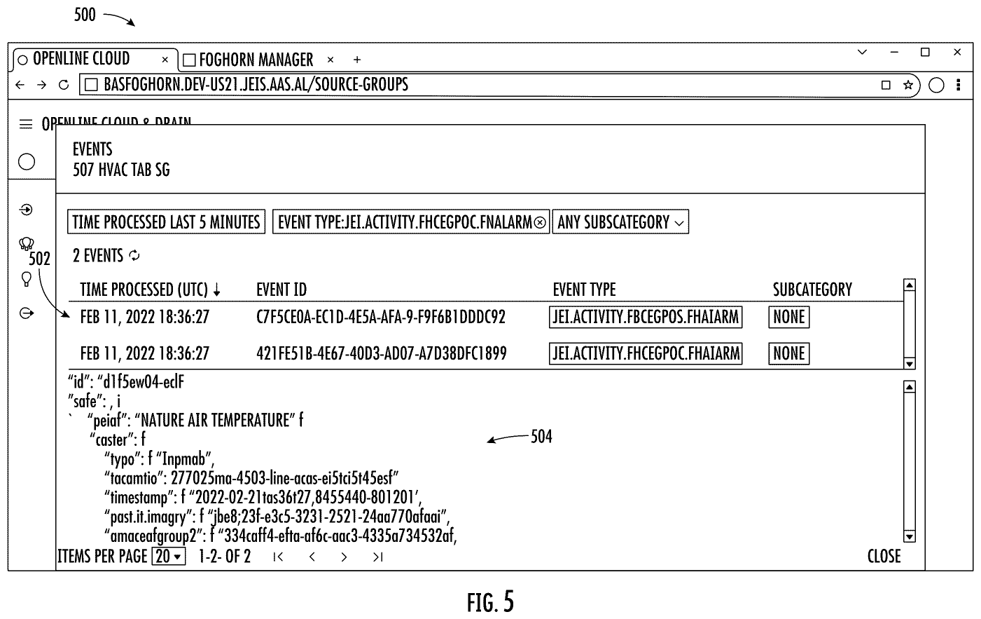

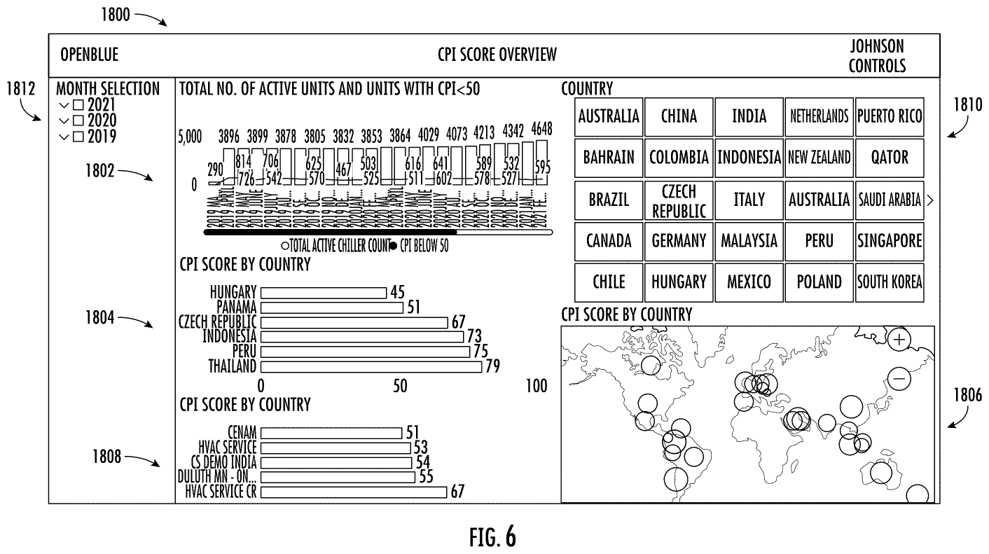

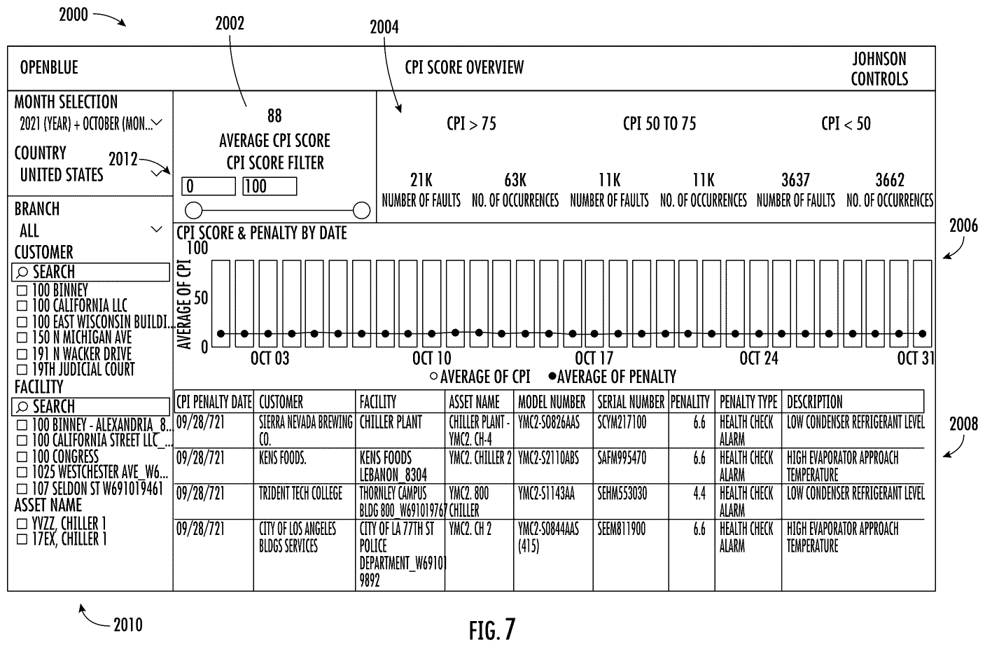

The cloud processing portion 308 of the cloud tier is shown as including an event processor 346, a message pipeline/storage 348, and enterprise applications 350. The event processor 346 may be configured to receive data and analytics outputs from the edge circuitry 108 and store such outputs. The event processor 346 may also be configured to perform additional (e.g., higher-level) analytics and processing of such information to generate additional insights and actionable steps or recommendations relating to the equipment unit 106. The message pipeline/storage 348 provides for communication between the event processor 346 and enterprise applications 350. The enterprise applications 350 can include various cloud-based capabilities associated with managing, tracking, and/or affecting operation of the equipment unit 106 and, in some scenarios other building equipment communicable with the cloud tier 102. For example the enterprise applications 350 may provide a distributor dashboard enabling comparison of equipment performance, events, etc. across many units of equipment, different facilities, different customers, different equipment owners, different technicians or sales representatives, etc. As another example, the enterprise applications 350 can provide a user interface (e.g., via a mobile application, via a webpage hosted by enterprise applications 350, etc.) that enables a user to view events, faults, etc. for the equipment unit 106 (e.g., as shown in FIG. 5 and described with reference thereto below) or a fleet of equipment as shown in FIGS. 6-7.

Referring now to FIG. 4, a view of an interface 400 provide user interface console 342 is shown, according to some embodiments. In the example shown, the interface 400 provided by the user interface console 342 is a webpage hosted by the analytics management portion 306 of the cloud system and shown as being accessed by and displayed on a personal computing device (e.g., laptop computer, desktop computer, etc.). In some embodiments, the interface 400 is provided on unified pane 116.

The interface 400 includes a menu 402 that includes buttons that enable a user to navigate to an edge device (e.g., edge circuitry 108) of a set of possible edge devices that can be managed by the analytics management portion 306 (e.g., multiple edge devices for a building site or portfolio). The menu 402 can include filtering and search features. In some embodiments, multiple edge devices (e.g., all edge devices of a selected equipment type) can be selected together and managed together.

The interface 400 also includes a tabs bar 404. The tabs bar 404 allows a user to select to view different information and different manageable features for a selected edge device. As shown, the tabs bar 404 includes selectable tabs for health, status, edge details, and solutions which show information about the edge devices. The tabs bar 404 also lists sensors, analytics, edge machine learning (ML), apps, and data publications which may correspond to views that provide customizable/manageable features of the device. In the example shown, an analytics tab 406 is selected from the tabs bar 404.

The analytics tab 406 is shown as including a list 408 of analytics (and/or other operations) available for execution by the edge device. As shown, the analytics may include data ingestion and tagging features, for example executable by the data ingestion layer 300 of the edge circuitry 108. The analytics are also show as including alarms and event processing that can be executed by analytics engine 332 of the edge circuitry 108 using expression-based programming, for example a set point delta transformation and alarming expression-based program. The analytics tab 406 also includes a column 410 indicating whether each item on the list 408 is enabled on the edge device (as shown, all listed items are enabled).

The analytics tab 406 also includes an add button 412. The add button 412 is selectable to add one or more additional analytics. The added analytics can be preprogrammed expressions in an expression-based language, for example, thereby allowing a user to select from a set of expert-created and validated expression-based logic. The analytics can also be user-created, for example via an expression language studio interface accessible by selecting a launch button 414 of the analytics tab 406. The studio interface may provide an intuitive experience for creating logic in an expression-based language for execution by the edge circuitry 108, in some examples without requiring software programming expertise. For example, the interface 400 may provide a development environment and programming language as described in U.S. Pat. No. 10,977,010, filed Apr. 21, 2020, the entire disclosure of which is incorporated by reference herein.

The analytics tab 406 thereby provides a user with options to remotely select, unselect, and customize logic to be executed by the edge circuitry 108. The logic executed by the edge circuitry 108 can thus be easily modified and updated remotely via the cloud manager 340. In some embodiments, many instances of the edge circuitry 108 (e.g., for multiple units of the same time of equipment installed at a facility or multiple facilities) can be updated together using the analytics tab 406, thereby enabling over-the-air customization of a fleet of equipment units.

Referring now to FIG. 5, an events interface 500 is shown, according to some embodiments. The events interface 500 can be provided on unified pane 116, for example. The events interface provides a list of events which occurred for a particular building or space. As shown, the events interface 500 shows a list of events detected locally at the equipment unit 106 by edge circuitry 108 executing expression-based pattern recognition logic activated via interface 400. The edge circuitry 108 can locally determine the occurrence of such events and provide information indicating that an event occurred to the cloud tier 102 without all data necessary to detect such an event uploaded to the cloud tier 102. Such an architecture can save bandwidth and cloud storage requirements, for example. The events interface can then provide a list 502 of such events and a details area 504 showing further details of the contextual data provided event notifications from the edge circuitry 108 (e.g., time stamp, event type, relevant points, etc.). The event data can also be provide in various other interfaces of a building automation system, for example integrated alongside building performance data and options for remotely controlling building equipment.

Referring now to FIGS. 6-7, dashboards for viewing data for a fleet of equipment units, for example data provided from edge circuitry of said fleet of equipment units, are shown, according to some embodiments. The dashboard 1800 of FIG. 6 and the dashboard 2000 of FIG. 7 can be provided on unified pane 116, for example. The dashboards 1800, 2000 may be provided as part of enterprise applications 350 as shown in FIG. 3, for example. Advantageously, the dashboards provide aggregated data for multiple equipment units for different building sites and, in some examples, equipment units owned or leased by different customers or building owners. The dashboards thereby enable a service branch, distributor, sales representative, technician, manufacturer expert, etc. to review performance across customers and sites, identify trends or outliners, determine areas or customers for updates, upgrades, maintenance, etc., and otherwise more easily manage large fleets of building equipment.

Referring particularly to FIG. 6, a dashboard 1800 is shown, according to some embodiments. The dashboard 1800 shows a monthly comparison widget 1802, a country graph widget 1804, a map widget 1806, a branch widget 1808, a country selection widget 1810, and a month selection widget 1812 arranged to be displayed simultaneously on a display screen of a user device (e.g., via unified pane 116).

The monthly comparison widget 1802 shows a total number of active units (e.g., rooftop units, chillers, other types of equipment) with a performance score (shown as a connected equipment performance index as described in U.S. Pat. No. 11,092,954, field Jan. 10, 2019, the entire disclosure of which is incorporated by reference herein) of less than a threshold value (shown as less than 50). In some examples, the performance scores is calculated locally on each unit of equipment, for example using expression-based analytics and/or machine learning algorithms. Performance scores below the threshold value can be considered as poorly performing, in need of control adjustments, in need of maintenance, or otherwise in need of intervention. The monthly comparison widget 1802 can be generated by processing the aggregated data from step 1704 and counting, for each month period a number of different devices associated with connected equipment performance indices for that month less than the threshold value and then displaying those total numbers as a bar graph as shown in FIG. 18. The monthly comparison widget 1802 can show a user general trends in how a fleet of connected equipment is degrading (increasing the number of poor performing units) and/or being serviced or better operated (decreasing the number of poor performing units) over time, e.g., over a period of two years on a month-to-month basis as in the example of FIG. 6.

The country widget 1804 displays a bar graph of the connected equipment performance index associated with each of multiple countries. Other geographic distinctions are included in other examples (neighborhoods, campuses, cities, counties, states, etc.). For example, the value for each country may be an average of all performance scores for all of the units of connected equipment in the particular country (or a median, etc. in other embodiments). The country widget 1804 may arrange the countries in order from worst (e.g., lowest) score to best (e.g., highest) score, so that a user can easily see which region has the worst-performing connected equipment. Although the example shows scores by country, other geographic categorizations can be used in various embodiments (states, territories, counties, states, regions, cities, neighborhoods, campuses, etc.). The country widget 1804 can allow a user to determine where to focus attention for improvements, maintenance, and other interventions.

The map widget 1806 shows similar data as the country widget 1804 visualized in a map view. In particular, the map widget 1806 shows a map (shown as a world map, but may be a map of a smaller region in other embodiments) which data visualized on the map to show connected equipment performance index values for different geographic regions shown on the map. In the example shown, each country in which connected equipment is located is provided with a circle (e.g., colored and/or shaded circle) which is sized and/or colored based on an average or other aggregate performance score associated with that country. In some embodiments, a larger circles indicates better scores while smaller circles indicate lower scores (or vice versa in other embodiments). In some embodiments, each country has a circle sized based on a number of units of connected equipment located in that country while the circles are colored based on performance index values (e.g., green for good/high values, yellow for moderate values, red for bad/low values). The map widget 1806 thus shows a graphical view of equipment performance across geographic areas.

The branch widget 1808 shows a graph of performance scores (e.g., connected equipment performance indices) for different branches, i.e., for different business units, departments, subgroups, subsidiaries, customers, service technicians, sales representatives, etc. associated with sets of connected equipment. As shown in FIG. 6, the branch widget 1808 shows a bar graph with a bar for each different branch, or at least for a subset of all different branches included in a given scenario (e.g., for the branches with the worst five scores). The branch widget 1808 may order the graph so that the worst branch (i.e., with the worst/lowest score) is shown first, enabling a user to easily see the branch which needs the most intervention, attention, maintenance, investment, etc. based on the aggregated data visualized on dashboard 1800.

The country selection widget 1810 and the month selection widget 1812 are configured to enable a user to reduce the amount of data displayed on the dashboard 1800. The month selection widget 1810 allows a user to select a month or subset of months for which the dashboard 1800 will display data and visualizations. For example, if a user selects a few months from a set of available months, the monthly comparison widget 1802, the country graph widget 1804, the map widget 1806, and the branch widget 1808 will update so that the monthly comparison widget 1802, the country graph widget 1804, the map widget 1806, and the branch widget 1808 visualizes data for the selected months. Other time periods (years, seasons, days of the week, particular dates, parts of days, hours, etc.) could be selectable in the same manner in various embodiments.

The country selection widget 1810 provides a button for each country included in the data and allows a user to select the countries for which data is desired to be displayed on the dashboard 1800. Other types of geographic areas (regions, states, territories, counties, cities, etc.) can be similarly selectable in other embodiments. In the example shown, if a user selects a subset of countries, the monthly comparison widget 1802, the country graph widget 1804, the map widget 1806, and the branch widget 1808 will update so that the monthly comparison widget 1802, the country graph widget 1804, the map widget 1806, and the branch widget 1808 visualizes data for the selected countries.

Referring now to FIG. 7, a dashboard 2000 of equipment fleet data is shown, in particular including a visualization of data from a selected one-month period. A user may be enabled to navigate to the dashboard 2000 via the dashboard 1800 of FIG. 6. The dashboard 2000 includes an average score widget 2002, an index buckets widget 2004, a timeline widget 2006, and events widget 2008, a field selection widget 2010, and a score filter widget 2012.

The average score widget 2002 is configured to show an average performance score for the subset of data represented in the selected (filtered) dataset. The index buckets widget 2004 shows the number of faults and the number of occurrences corresponding to equipment performance scores in different ranges (shown as greater than 75, between 50 and 75, and less than 50). The faults, performance scores, etc. can be calculated at the edge and then aggregated at the cloud for display via the dashboard 2000, thereby reducing bandwidth on network communications and resource demand on a cloud system that would be present in an embodiment where all data is uploaded to the cloud and processed there to identify faults and calculate performance scores.

The timeline widget 2006 is configured to show a bar chart of connected equipment performance scores for each day in the selected month, spatially arranged in temporal order. The bar chart is overlaid with a line chart representing an average penalty value for each day. The timeline widget 2006 thereby shows a performance score and a penalty value for each day, for example so that a user could easily and quickly see any trends which occurred over the course of the selected month.

The events widget 2008 is configured to show events which occur relating to the connected equipment in the selected month (or satisfying other filter criteria). Events may include detected faults, alarms, or other notable conditions or events relating to the connected equipment. The events widget 2008 can list the date, entity, facility, particular equipment asset, model number, serial number, penalty value, penalty type, and description for each event, for example. Events can be determined at the edge by the equipment using complex expression-based event processing, for example.

The field selection widget 2010 is configured to present lists of categorizations from which the user can select particular filters to further apply to the data used to generate the dashboard 2000. For example, the field selection widget 2010 is shown as including a customer list (allowing selection of one or more customers or other entities), a facility list (allowing selection of one or more particular facilities), and an asset name list (allowing selection of particular equipment assets). Once one or more additional fields are selected by a user via the field selection widget 2010, the dashboard 2000 updates so that the widgets 2002-2008 visualize data corresponding only to the selected fields. A user is thereby enabled to select the particular dataset(s) the user wishes to see visualized on the dashboard 2000.

The score filter widget 2012 is configured to accept a request to update the dashboard 2000 to only visualize data corresponding to performance scores in a user-selectable range. FIG. 20 shows the score filter widget 2012 set to show scores between 0 and 100, with the upper value and the lower value adjustable by numerical input or by digital manipulation of a slider feature. For example, if a user resets the range shown in score filter widget 2012 to scores between thirty and 70, the widgets 2002-2008 will update to only show data corresponding to such data points. As one example, the events widget 2008 will be updated to only show events which occurred while performance was scored in the selected range. The dashboard 2000 thereby enables yet another way to sort and filter the displayed data.

The dashboard 1800 and the dashboard 2000 thereby provide various ways of visualizing and understanding advance performance information from units of building equipment spread across buildings, geography, end users, technicians, etc. Such dashboards can be enabled in a seamless manner by performing the advanced event processing and performance scoring at the edge for each unit of equipment, and then aggregating that higher-level information at the cloud tier 102 for display to a user. Efficient and reliable presentation of the dashboard 1800 and the dashboard 2000, with little or no manual configuration, is thereby enabled by the present disclosure.

Edge Device with Controller Health Application

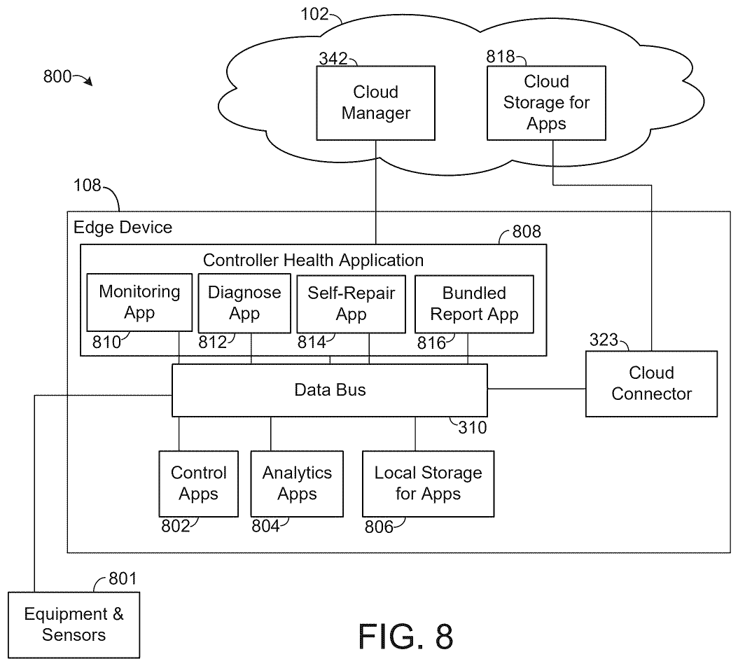

Now referring to FIG. 8, a system 800 is shown, according to some embodiments. The system 800 can be a portion of the building automation system 100, for example an implementation of the system illustrated in FIG. 3. The system 800 is shown as including edge device 108 and cloud tier 102, which can be configured as described above while additionally or alternatively including features shown in FIG. 8 and described in the following passages.

As shown in FIG. 8, the edge device 108 provides the data bus 310 and cloud connector 323, where the data bus can exchange data with equipment and sensors 801 at a building site (and/or other data sources) while the cloud connector 323 facilitates connectivity between the edge device 108 and the could tier 102, for example as described above with reference to the data bus 310 and cloud connector 323 as shown in FIG. 3.

The edge device 108 is also shown as providing control applications (“apps”) 802 and analytics apps 804 connected to the data bus 310, such that the control apps 802 and the analytics apps 804 can execute by exchanging data with the data bus 310. The control apps 802 can include one or more containerized or dockerized control programs (control logic, control routines, etc.) for generating control outputs for the equipment and sensors 801, for example based on data from the data bus 310. The analytics apps 804 can include one or more containerized or dockerized programs for providing advanced processing, analytics, metrics, supervisory decision-making, report generation, or other desired operations. The control apps 802 and the analytics apps 804 can be implementations of the apps 338, product apps 336, and/or analytics engine 322 and include features described with reference thereto above. For example, in some embodiments, one or more control apps 802 and/or analytics apps 804 use an edge-adapted machine learning model or other artificial intelligence algorithm executed locally on the edge device 108, for example in a containerized or dockerized manner that uses data from and provides data to the data bus 310.

The edge device 108 is also shown as including local storage for apps 806. The local storage for apps 806 on the edge device 108 can include one or more computer-readable media for storing data, instructions, models, logs, bundles of data, status information, etc. as may be suitable to support execution of control apps 802, analytics apps 804, or other functions of the edge device 108 (e.g., operations associated with the container health application 808 described below) via data stored locally on the edge device 108.

The edge device 108 is also shown as providing a controller health application 808 in communication with the data bus 310. The controller health application 808 includes a monitoring application 810, a diagnose application 812, a self-repair application 814, and a bundled report application 816, which can be provided as separate dockerized or containerized applications, as a unified application in one container, and/or any combination of combined and separate applications. The controller health application 808 is configured to, onboard the edge device 108 at the edge, monitor operations of the edge device 108, detect and diagnose issues in edge device 108 operations, execute self-repair routines to address issues in edge device 108 operations, and generate bundled logs of relevant data for reporting issues and resolutions (e.g., to a user).

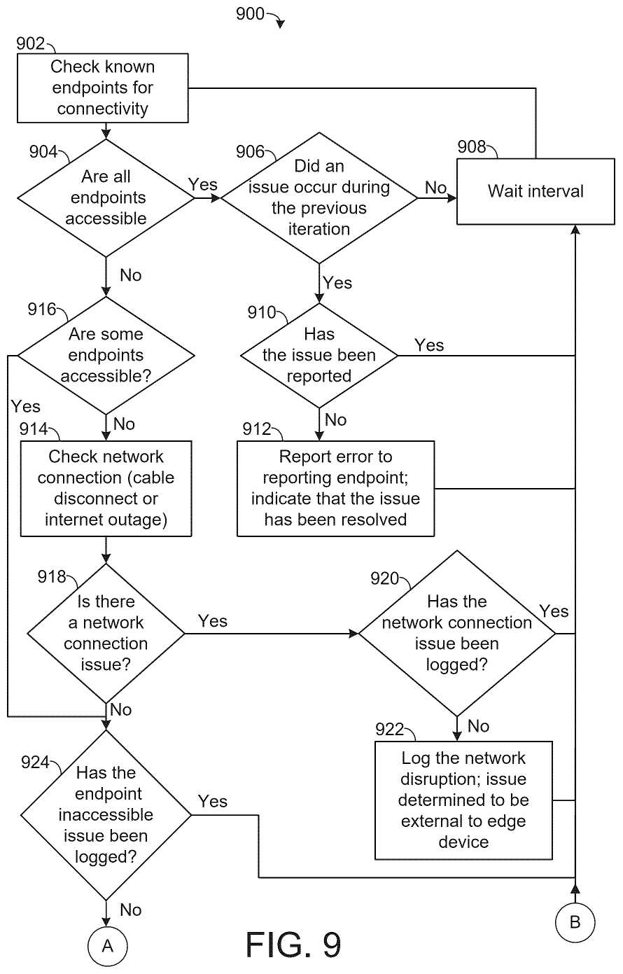

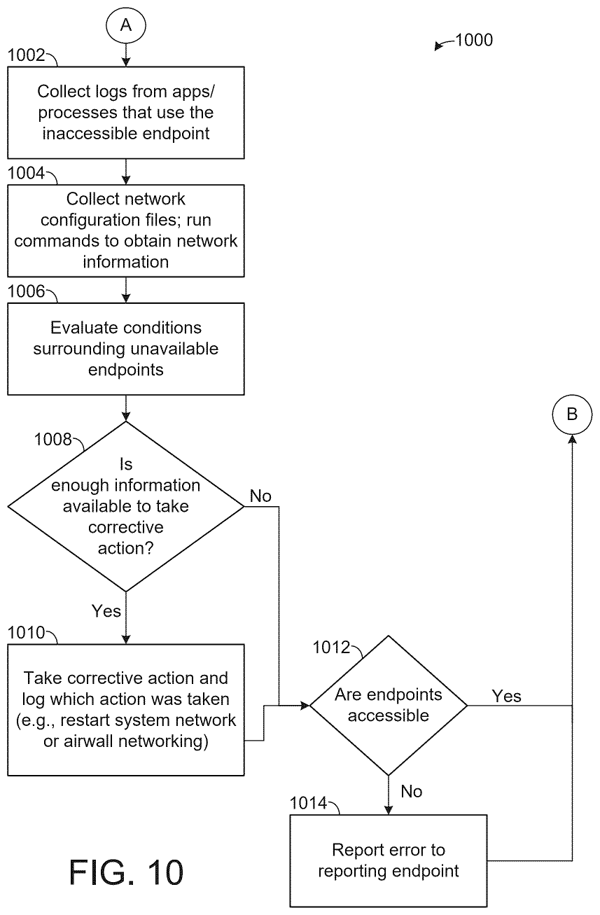

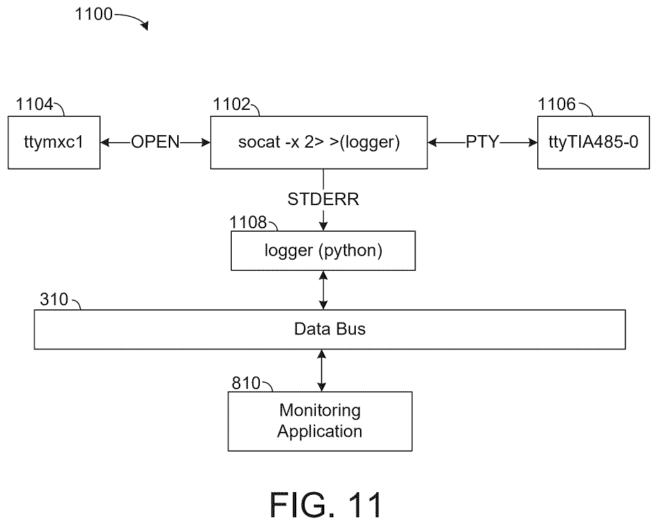

The monitoring app 810 is configured to monitor data exchanged with and streaming on the data bus 310 by various other apps, for example by control apps 802 and analytics apps 804. The monitoring app 810 can use one more rules-based or artificial intelligence approaches to detecting issues reflected in such data, for example for detecting lost connections between endpoints for data, anomalies in data, performance degradation, error triggers, missing sources of data, or other issues detectable via data on the data bus 310. For example, in some embodiments, the monitoring app 810 can provide a check of network and endpoint connectivity by executing a process as shown in FIGS. 9-10 and/or using logic as illustrated in FIG. 11. In various embodiments, issues monitored for and detectable by the monitoring app 810 can include connection issues (e.g., failed connectivity to remote server, serial communication issues to networked equipment, WiFi-related issues, Ethernet-related issues, issues with cloud services such as network security operations including airwall or firewall operations, local domain name service errors, network adapter failures), application issues (e.g., software faults, critical logs/traces, critical system events, MSTP errors, collisions, crash dumps, application health), device computing performance and load issues (e.g., CPU usage, memory usage, disk usage, system load, capacity issues, timeouts, denial-of-service attack detection, etc.), security related issues (e.g., irregular number of login requests, irregular network traffic, unnecessary pings, cyber-security-related events), and/or various other performance and health related categories (e.g., various issues detectable by artificial-intelligence monitoring of device parameters).

In response to detecting an issue, the monitoring app 810 can provide an indication of such detection of an issue to other applications, for example to the diagnose app 812, the self-repair app 814, and the bundled report app 816, and can store information relating to the issue in local storage for apps 806. For example, the monitoring app 810 can cause collection (e.g., of relevant data points, kernel and application system traces, logs, faults list, configuration data (e.g., non-sensitive configurations) such as network configurations, state, system archives, equipment models, traces, etc. as may be relevant to various issues detectable by the monitoring app 810.

The diagnose app 812 is configured to diagnose issues identified by the monitoring app 810, for example to identify a type of the issue, a cause of the issue, an app or container responsible for the issue, or otherwise diagnose one or more characteristics of issues identified by the monitoring app 810. The diagnose app 812 can perform its diagnosis using data from the monitoring app 810 and/or by exchanging data with the data bus 310 to receive information relating to operations of various apps (e.g., control apps 802, analytics apps 804), to query or otherwise interact with such apps, or to retrieve information from local storage for apps 806. In some embodiments, the diagnose app 812 categorizes and scrolls through a database of known issues occurred in the past (e.g., stored on local storage for apps 806, stored in cloud storage for apps 818) to identify a comparable issue to the currently-detected issue and/or to identify various recovery actions taken in the past.

In some embodiments, the diagnose app 812 uses at least one artificial intelligence model, for example an edgified classification model adapted to classify a category of or resolution for an issue identified by the monitoring app 810 using various data exchanged with the data bus 310 relating to the issue. The at least one artificial intelligence model can be trained or fine-tuned for improved accuracy for a particular edge device 108 by providing reinforcement learning at the edge locally on the edge device 108, for example based on data stored in the local storage for apps 806 and/or bundled by the bundled report app 816 as described below. The diagnose app 812 can thereby output a diagnosis of an issue, for example a cause of the issue, a type of the issue, and/or a resolution for or other step to be taken in response to the issue.

The self-repair app 814 is configured to execute self-repair routines for the edge device 108, for example in response to detection of an issue by the monitoring app 810 and/or diagnosis of the issue by the diagnose app 812. In some embodiments, a self-repair routine can include automatically identifying a trigger point based on stored algorithms to initiate a system recovery process (e.g., automatically a point to recover to) and/or using various artificial intelligence approaches to select (e.g., via a classification model) or artificially generate (using a generative AI model such as a large language model) one or more other actions to take to attempt resolve a detected issue.

In some embodiments, the self-repair app 814 uses at least one artificial intelligence model (e.g., generative artificial intelligence) configured to infer a most effective resolution from a set of past resolutions attempted by the edge device and/or by other edge devices experiencing similar issues. In some such embodiments, the self-repair app 814 uses data stored in local storage for apps 806 or cloud storage for apps 818 in evaluating such sets of past resolutions. In such embodiments, datasets of past resolutions can be stored locally on the edge device 108 and/or in the cloud tier 102, for example dynamically moved between the cloud tier 102 and the edge device 108 to adaptively facilitate operations of the self-repair app 814. In some embodiments, the system 800 uses generative artificial intelligence (e.g., in the cloud tier 102) to manage the identification and flow of successful resolutions across edge devices for use by the self-repair apps of various edge devices 108 in an enterprise system.

The self-repair routine can then include executing such an action, for example by restarting or restoring the edge device 108 or a portion thereof (e.g., an individual app, a particular container, an aspect of the data bus 310, the cloud connector 323) and/or otherwise reconfiguring settings, parameters, network configurations, or other attributes of the edge device 108 or a portion thereof (e.g., an individual app, a particular container, an aspect of the data bus 310, the cloud connector 323). Upon execution and completion of the self-repair action, the self-repair app 814 (e.g., together with the monitoring app 810 and the diagnose app 812) can check whether the identified issue has been resolved or whether the self-repair app 814 should execute another, different resolution to address the issue (in which case such a resolution can be executed by the self-repair app 814). The self-repair app 814 can thus operate until an issue is resolved or a determination is reached that the identified issue is not self-repairable locally by the edge device 108.

The bundled report app 816 is configured to collect and bundle logs of data relating to issues identified by the monitoring app 810, diagnosed by the diagnose app 812, and/or repaired by the self-repair app 814. For example, the bundled report app 816 can bundle, in a log, relevant data which caused the monitoring app 810 to detect the issue and/or otherwise from the time around the issue was detected (e.g., various data on the data bus 310 at the time the issue occurred); data relating to the trigger condition, rule, model, algorithm, etc. used to identify and/or diagnose the issue; data relating to one or more self-repair actions or resolutions attempted by the self-repair app 814, and results of the self-repair actions or resolutions (e.g., data reflecting relevant system performance after such actions are taken). Such data can include triggers, results, diagnostics, recovery actions, configuration data, equipment models, traces, network configurations, states, etc. in various embodiments. Such data can exceed the set of data which would otherwise be saved in a scenario where an issue was not detected, and can include data which may otherwise be automatically deleted or otherwise pass out of memory or the data bus without being retained in the absence of an issue being detected.

In some embodiments, the bundled report app 816 is configured to cause, for example via commands provided over the data bus 310, additional data to be provided applications, equipment, and/or sensors. For example, the bundled report app 816 can cause, via the data bus 310, a camera or other sensor of the equipment and sensors 801 to provide additional data (e.g., streaming video feed, higher-frequency of still images as under standard operations in the absence of a detected issue) to the data bus 310 (e.g., more data than would otherwise be provided in the absence of a detected issue).

Various such data can be collected as a bundle associated with an issue and stored in the local storage for apps 806 and/or uploaded as a bundle (e.g., batch) to the cloud tier 102 (e.g., cloud storage for apps 818), for example via the cloud connector 323 at such time as network bandwidth and connectivity allows and/or upon a user request received at the edge device 108 (e.g., via a user interface interacting with the cloud tier 102). The bundled report app 816 can thereby collect a more robust log of data relating to an issue than would be provided without the teachings herein, for example enabling improved operations of the controller health applications (e.g., via reinforcement learning) and/or improving visibility by users or remote systems and algorithms into the conditions around issues which occurred at the edge device 108.

In some embodiments, the bundled data is used for training of artificial intelligence (e.g., machine learning) models for improved detection and repair. For example, in some embodiments, the cloud manager 342 of the cloud tier 102 provides for cloud-based training of such AI models, for example reinforcement learning of models deployed in the controller health application 808 based on the bundled data, such that said models improve over time as issues are detected and self-resolved by the controller health application 808. Such updated/improved models can be trained in format suitable for training at the cloud and then repackaged in an edge-adapted (“edgified”) form for efficient execution on the edge device 108 and provided as over-the-air updates to the controller health application 808 for local execution on the edge device 108. Various other adjustments, user management, training, logic selections, etc. can be made via the cloud manager 342 to affect operations of the controller health application 808, in various embodiments.

In some embodiments, the cloud tier 102 provides a graphical user interface (e.g., via a web browser) to a user computing device (e.g., laptop, desktop, smartphone, etc.), for example providing access to the bundled data via the cloud storage for apps 818 and/or cloud manager 342. In some embodiments, the cloud tier 102 uses a large language model or other generative artificial intelligence technique to automatically generate a summary of a report of bundled log data from the bunded report app 816, for example describing in natural language a summary of what occurred at the edge device 108 as reflected in the bundled log data (e.g., what issue occurred, how it was detected, how it was self-repaired). The teachings herein can thereby provide visibility for users into the self-monitoring and self-repairing activities of the edge device 108.

Advantageously, by actively monitoring and self-repairing device performance locally at the edge enabled by exchanging data with a common data bus also used by various other containerized applications (e.g., control apps 802 and analytics apps 804) and communicable with equipment and sensors 801, performance issues can be detected and resolved in real-time and under conditions when cloud connectivity may be intermittent, unavailable, or bandwidth-limited. Such an approach can improve edge device reliability and resolve issues at a much faster pace as compared to an approach under which a user wound need to manually observe a problem and report to customer service before resolution can begin. Such advantages can be particularly important in the context of the present application given that the edge device 108 is contemplated as controlling physical equipment, such as heating and cooling equipment for a building and/or other industrial equipment, which should be operated properly substantially continuously to control environmental conditions or the like.

Referring now to FIGS. 9-10, flowcharts of a technique including a process 900 (shown in FIG. 9) and a process 1000 (shown in FIG. 10) which can be executed by the controller health application 808 are shown, according to some embodiments. The process 900 and the process 1000 can be executed together as described below to provide for automated detection, resolution, and reporting of endpoint connection issues for an edge controller such as edge device 108.

At step 902, known endpoints are checked for connectivity. Endpoints can include network locations external to the edge device 108 (e.g., equipment, other controllers, building automation system devices, cloud tier, sensors, etc.) and/or endpoints of the edge device 108 (e.g., endpoints within various containerized applications of the edge device 108. A determination is made (block 904) as to whether all endpoints checked in step 902 are accessible. If so, a determination is then made (block 906) as to whether an issue occurred on a previous iteration of executed process 900. If not, process 908 proceeds to step 908 where the process 900 waits for an interval (e.g., set period of time) before returning to step 902 to restart process 900. If an issue did occur during the previous iteration (“yes” at block 906), then a determination is made (block 910) as to whether the issue has been reported. If the issue which occurred during the previous iteration has already been reported (“yes” at block 910), process 900 proceeds directly to step 908 to wait to initiate another iteration. If the issue which occurred during the previous iteration has not yet been reported (“no” at block 910), at step 912 the error is reported to a reporting endpoint along with an indicate that the issue has been resolved. Following such reporting in step 912, process 900 can proceed to wait an interval at step 908 before restarting for another iteration at step 902.

If, based on the check of endpoints for connectivity in step 902, a determination is made that not all endpoints are accessible (“No” from block 904), then process 900 proceeds to determine (at block 916) whether some endpoints are accessible (i.e., whether a subset of the endpoints are accessible or if all endpoints being checked are inaccessible). If no endpoints being checked are accessible (all such endpoints inaccessible) (“No” at block 916), process 900 process to step 914 where a network connection checked, for example by automatically checking for a cable disconnect or internet outage or otherwise checking for a network connection issue. If a network connection issue is determined (“Yes” at step 918), process 900 proceeds to step 920 where a determination is made as to whether the network connection issue has been logged (block 920). If the network connection issue has not been logged (“No” at block 920), the network disruption is logged in step 922 and the issue is determined to be external to the edge device, with the process 900 then waiting an interval in step 908 before starting another iteration. If the network connection issue has already been logged (“Yes” at block 920), the process 900 proceeds from block 920 to wait an interval in step 908 before starting another iteration.

If some endpoints are accessible (“Yes” at block 916) or there is not a network connection issue (“No” at block 918), a determination is made (block 924) of whether the endpoint inaccessible issue has been logged. If the endpoint inaccessible issue has already been logged (“Yes” at block 924), process 900 can proceed to wait an interval at step 908 before starting another iteration. If the endpoint inaccessible issue has not already been logged (“No” at block 924), process 900 can initiate process 1000 to diagnose and attempt to correct the endpoint inaccessible issue as described below with reference to FIG. 10.

As shown in FIG. 10, process 1000 can be initiated at step 1002 following process 900, as indicated by the flow to and from point “A” in FIGS. 9 and 10. At step 1002, logs are collected from apps (e.g., dockerized or containerized apps on a data bus) that use the inaccessible endpoint. For example, both a control application 802 and an analytics application 804 can use the same endpoint (e.g., a sensor point, equipment unit, etc.) for control and/or analytics operations, such that step 1002 can include obtaining logs from both the relevant control application 802 and analytics application 804. Such logs can provide information relating to the interaction of such applications with the relevant endpoint, and can provide data associated with, for example, last known interactions with the endpoints, actions taken by the applications which may have affected accessibility of the endpoint, application software errors within the applications which may affect accessibility of the endpoint, etc. At step 1004, network configuration files are collected and commands are run to obtain network information. Step 1004 can include causing data to be generated relating to network availability, network configurations, network addresses, network bandwidth, etc. which may be relevant to endpoint accessibility even where no general network connectivity issue was found in step 914.

At step 1006, conditions surrounding unavailable endpoints are evaluated. For example, logs and network files and information collected in steps 1002 and 1004 can be evaluated in step 1006. Step 1006 can include applying such conditions as inputs to at least one artificial intelligence model which is trained to diagnose an issue causing the unavailability of endpoints, identifying a corrective action to be taken, and/or identify scenarios in which insufficient information is available to take a corrective action. Such techniques in step 1006 can provide for a determination (in block 1008) as to whether enough information is available to take a corrective action (e.g., whether enough information is available for the artificial intelligence model to identify a corrective action expect to be able to resolve the endpoint unavailability issue).

If enough information is available to take a corrective action (“yes” at step 1010), process 1000 process to step 1010 where the corrective action is taken and the action taken is logged. The corrective action can include restarting system network or airwall networking (e.g., network security protocols and components) and/or otherwise taking corrections in networks, endpoint devices (e.g., by providing commands to equipment or sensors to restart or reconfigure), applications on the edge device (e.g., adjusting parameters used by applications that interact with the endpoint), etc., in various embodiments. Such actions can be executed locally by the edge device 108 implement the corrective action.

Following such corrective action in step 1010, or if insufficient information is available to take a corrective action (“No” at block 1008), a determination is made (block 1012) as to whether the endpoints are now accessible. For example, the endpoints can be checked for accessibility, for example in a similar manner as in step 902, with certain endpoints potentially now having been restored to accessibility by the corrective action. If some endpoints remain inaccessible (“no” at block 1012), the remaining error is reported to the reporting endpoint at block 1014. Following block 1014, or if all endpoints being checked are now accessible (“yes” at block 1012), process 1000 can flow back to process 900 (as indicated by point “B” in FIGS. 9 and 10), in particular to wait an interval at step 908 before starting another iteration of process 900. Processes 900 and 1000 thereby combine to monitor endpoint accessibility, report endpoint accessibility issues, and attempt to resolve endpoint accessibility automatically and locally at the edge where feasible (e.g., where automatically determined to not be associated with a network error out of the control of the edge device 108 and where sufficient information exists to identify and take a corrective action predicted to resolve the endpoint accessibility issue).

Referring now to FIG. 11, logic 1100 for monitoring and detecting connection issues via a data bus 310 is shown, for example as may be implemented by, for, within, in parallel with, etc. the monitoring application 810. As shown in FIG. 11, a socat command 1102 is used to check whether a connection is maintained between two endpoints, for example between two containerized applications or between an endpoint external to the edge device 108 and an application provided by the edge device 108. The socat command 1102 can provide such functionality via interactions with ttymxc1 block 1104 and ttyTIA485-0 block 1106, which can relate to availability of serial ports and cable connections to such serial ports. Logic 1100 can include running a logger 1108, for example a python-coded logger, which can log data from the data bus 310 and provide connections with the socat command 1102 to enable data logging activities relating to monitoring and detecting connection issues for an edge device as an example feature that can be used with the various teachings herein.

While FIGS. 9-11 illustrate sequences of steps for monitoring, checking, diagnosing, and resolving particular issues that may occur for edge devices, the teaching herein are not limited to such approaches and can be adapted for handling of various types of issues and resolutions using the various teachings presented herein. For example, as discussed above, an artificial intelligence model can be used to infer a most effective resolution from a set of potential resolutions based on an autonomous analysis of the currently-detected issue and similar issues that occurred in the past (either on the same edge device, or, in some embodiments, on other edge devices), for example without following a prescribed rules-based process and rather following a dynamically-adaptive artificial-intelligence-driven technique.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. An edge controller for building equipment, the edge controller comprising circuitry programmed to provide:
a data bus locally on the edge controller;
a plurality of containerized applications executing on the edge controller by exchanging data with the data bus; and
a controller health application executing on the edge controller and monitoring health of the plurality of containerized applications via the data bus.

2. The edge controller of claim 1, wherein the controller health application is configured to provide health monitoring via data logging using at least a subset of the data exchanged with the data bus by the plurality of containerized applications.

3. The edge controller of claim 1, wherein the controller health application is configured to execute a self-repair routine for the edge controller in response to detecting an issue with at least a first application of the plurality of containerized applications.

4. The edge controller of claim 3, wherein the self-repair routine comprises:
using at least one artificial intelligence model to identify a resolution to the issue; and
automatically implementing the resolution at the edge controller.

5. The edge controller of claim 1, wherein the controller health application is configured to log additional data streaming on the data bus in response to detecting an issue with at least a first application of the plurality of containerized applications.

6. The edge controller of claim 5, wherein the controller health application is configured to log the additional data by saving the additional data to local data storage of the edge controller.

7. The edge controller of claim 5, wherein the circuitry comprises a port coupled to the data bus to receive measurements from a sensor and provide an output to the sensor, wherein the device health application is configured to cause the output to be provided to the sensor in response to detecting the issue, the output causing the sensor to stream the additional data to the data bus.

8. The edge controller of claim 6, wherein the sensor is a camera.

9. The edge controller of claim 5, wherein the circuitry is further programmed to provide a network connection to a remote server, wherein the device health application is configured to generate a bundle comprising the additional data and provide the bundle to the remote server via the network connection.

10. The edge controller of claim 1, wherein the controller health application is further configured to:
attempt execution of a plurality of resolutions to a plurality of issues with the plurality of applications;
log results of the execution of the plurality of resolutions to the plurality of issues with the plurality of applications; and
train, locally on the edge device, a machine learning model of the controller health application to determine a future resolution based on the log.

11. The edge controller of claim 1, wherein the controller health application is configured to:
check known endpoints for connectivity;
in response to at least one of the endpoints lacking connectivity, check for a network connection; and
in response to a combination of the network connection and the at least one of the endpoints lacking connectivity:
collect logs from a subset of the plurality of containerized applications based on the subset using the endpoint; and
take a corrective action based on the logs.

12. The edge controller of claim 1, wherein the controller health application is configured to monitor streaming data on the data bus while the edge controller abstains from transmitting at least some of the streaming data off of the edge controller.

13. A building management system, comprising:
an equipment unit operable to heat, cool, or ventilate a building space;
a sensor configured to measure a condition of the building space;
an edge controller configured to receive a measurement of the condition of the building space from the sensor and control the equipment unit, wherein the edge controller is further programmed to provide:
a data bus locally on the edge controller and configured to receive the measurement from the sensor and enable a control output to be provided to the equipment unit;
a plurality of containerized applications executing on the edge controller by exchanging data with the data bus, at least one of the plurality of containerized applications generating the control output based on the measurement; and
a controller health application executing on the edge controller and monitoring health of the plurality of containerized applications via the data bus.

14. The building management system of claim 13, wherein the edge controller is located at a building site proximate the equipment unit and the sensor.

15. The building management system of claim 14, wherein the controller health application is configured to:
provide health monitoring via data logging using at least a subset of the data exchanged with the data bus by the plurality of containerized applications; and
execute a self-repair routine for the edge controller in response to detecting an issue with at least a first application of the plurality of containerized applications.

16. The building management system of claim 15, wherein the self-repair routine comprises:
using at least one artificial intelligence model to identify a resolution to the issue; and
automatically implementing the resolution at the edge controller.

17. The building management system of claim 13, wherein the controller health application is configured to check connectivity to one or more endpoints.

18. The building management system of claim 13, wherein the controller health application is configured to log additional data streaming on the data bus in response to detecting an issue with at least a first application of the plurality of containerized applications.

19. The building management system of claim 13, wherein the controller health application is configured to cause the sensor to provide the additional data to the data bus in response to detecting the issue.

20. The building management system of claim 13, wherein the sensor is a camera and the additional data is streaming video.
